(19) United States
(12) Patent Application Publication
(10) Pub. No.: US 2009/0074637 A1
(43) Pub. Date: Mar. 19, 2009

(54) Optimized Modular Microfluidic Devices

(76) Inventors: Michael C. Murphy, Baton Rouge, LA (US); Dimitris E. Nikitopoulos, Baton Rouge, LA (US); Steven A. Soper, Baton Rouge, LA (US); Pin-Chuan Chen, Baton Rouge, LA (US); Daniel S.-W. Park, Baton Rouge, LA (US); Mateusz L. Hupert, Baton Rouge, LA (US)

Correspondence Address: PATENT DEPARTMENT;TAYLOR, PORTER, BROOKS & PHILLIPS, L.L.P, P.O. BOX 2471, BATON ROUGE, LA, 70821-2471, US

(21) Appl. No.: 12/164,356

(22) Filed: Jun. 30, 2008

Related U.S. Application Data
(63) Continuation-in-part of application No. 11/933,836, filed on Nov. 1, 2007, now abandoned.
(60) Provisional application No. 60/856,415, filed on Nov. 3, 2006.

(51) Int. Cl. B01J 19/00

(52) U.S. Cl. 422/206; 422/240

(57) ABSTRACT

Passively aligned modular microfluidic devices, and a method for fabricating such passively aligned polymeric modular microfluidic devices have been reported. The modular units fabricated are plurality of integrated microdevices. Also reported are microfluidic devices wherein isolated temperature zones exist so that the temperature within each zone may be distinctly and accurately controlled, and a method for fabricating such microfluidic devices wherein there are isolated temperature zones so that the temperature within each zone may be distinctly and accurately controlled. Such devices allow one to define constant temperature zones along a microfluidic channel where different reactions or stages of reactions occur.

This is a continuation-in-part of co-pending application Ser. No. 11/933,836, filed Nov. 1, 2007, which claims benefit of the Nov. 3, 2006 filing date of U.S. Provisional Application Ser. No. 60/856,415 under 35 U.S.C. § 119(e).

The development of this invention was partially funded by the Government under grant number R24-EB-002115-03 from the National Institutes of Health and grant number EPS-0346411 from the National Science Foundation. The Government has certain rights in this invention.

This application pertains to aligned polymeric modular microfluidic devices and to a method for precisely aligning polymeric modular microfluidic devices; and to multi-temperature micro-cyclic reactors in which the temperature zones are distinct and isolated, and to a method for fabricating multi-temperature micro-cyclic reactors in which the temperature zones are distinct and isolated.

Modular microdevices are known but most tend to be constructed with silicon, glass, or metal. The main difficulty in fabricating polymeric modular microdevices is assembling individual units that are properly aligned. Because polymeric materials tend to be less rigid than materials such as silicon, glass, and metal, attempts to align separate polymeric units have been less successful. For example, while the method of exact kinematic constraints has been used to align more rigid materials, it is not known to have been previously used to align polymers on the microscale. In general, polymers have not been considered precision materials suitable for micro-scale alignment.

While combinations of functionality within a single unit have been demonstrated, for example, for DNA amplification using bench-scale reactors, such units tend to consume a great deal of reagent, tend to be slow, and tend to be large. Existing microdevices with multi-functionality tend to be serially aligned on a single chip, whereby each chip must be fabricated for a dedicated purpose. In contrast, modular multi-functional units may be assembled by combining chips, for example, each having a single functionality or multi-functionality.

Alignment using the long assembly loop method (Trinkle C. A., Morgan C. J., Lee L. P., “High Precision Assembly of Soft-Polymer Microfluidic Circuits,” Proceedings of ASME IMECE 2006-14631, Chicago, Nov. 5-10, 2006) has been used to assemble multiple layers of poly-dimethylsiloxane (PDMS) in a stack using a kinematic coupling system between an alignment plate and a base. Alignment during the PDMS casting process was achieved by using polyether ether ketone (PEEK) tubing inserted across different layers. This approach appears to require that each assembly be individually molded, causing variations with every mold insert because of variability in mold flatness.

Compression seal fittings have been used for self-alignment between different silicon wafers, for example, in micro-finger joints formed by etching periodic, vertical grooves in opposing faces of wafers (Gonzalez, C., Collins, S. D., Smith, R. L., 1998, “Fluidic Interconnects for Modular Assembly of Chemical Microsystems,” Sensors and Actuators B, vol. 49, pp 40-45). In this method, the wafers were assembled with friction between two sets of micro-finger joints, creating a locking mechanism between the pieces. This approach is overconstrained, which requires extremely precise fabrication or external force to be applied during assembly to match all fingers with groves. Further, this approach may result in inconsistent vertical positioning of the assembled components.

A hybrid micro-system has been reported, comprising a polyimide poly (methylmethacrylate) (PMMA) and polycarbonate system, with nine different functional layers (Martin, P. M., Matson, D. W., Bennett, W. D., Hammerstrom, D. J., 1999, “Laminated Plastic Microfluidic Components for Biological and Chemical Systems,” J Vac. Sci. Technol. A, vol. 17, no. 4, pp 2264-2269). There is no indication of how the laminations were aligned or the accuracy of the alignment.

Multi-well micro-titer plates are well known. However, typically conventional titer plates serve only to contain samples and reagents in the wells. Further processing is typically implemented by placing the titer plate into a bench-top instrument, for example, a thermal cycler, an ultra-centrifuge, or a capillary array. While a particular reaction may be carried out in parallel for a large number of samples, the wells are typically neither interconnected nor modular.

Shulte et al. (U.S. Pat. No. 6,742,661) have described a device that connects two or more wells in a plate to form a microfluidic device.

Microfabrication of 96-well capillary electrophoresis devices has been demonstrated, but minimum feature dimensions and pattern densities were limited by the size of the finger mills used. (Gerlach, A., Knebel, G., Guber, A. E., Heckele, M. Hermann, D., Musilia, A. and Schaller, T., 2002, “Microfabrication Of Single-Use Plastic Microfluidic Devices For High-Throughput Screening And DNA Analysis,” Microsystems Technologies, vol. 7, nos. 5-6, pp. 265-268.)

Oldenburg (U.S. Pat. No. 7,025,120) has described a multi-well thermal device, which includes a well plate cover with probes that may heat or sonicate a sample. However, this device appears to incorporate neither microfluidics nor modularity.

Laboratory instrumentation for cyclic reactions such as the polymerase chain reaction (PCR) typically comprises 96 reactor units and a block thermal cycler. The entire chamber containing the analyte and the reagent must be heated and cooled for each step of each cycle.

Continuous flow devices that transport reactants through separate temperature zones permit faster processing. Existing continuous flow devices, however, often require channel lengths greater than one meter. Precise construction of such instruments is difficult and expensive.

Each temperature zone within a multi-temperature microfluidic reactor is typically heated by applying heat directly to the substrate of the microreactor. Direct heating of a substrate containing the channel appears to provide reasonably uniform heat flux to the surface of the microreactor, but not necessarily uniform temperature to the microfluidic channel itself, because it appears that some heat transfers between zones, as well as to the environment. In some applications, grooves have been added to the substrate to reduce heat conduction between temperature zones. Poorly defined temperature zones tend to diminish reactor performance.

The PCR, a repetitive cycling reaction that is used to amplify specific DNA sequences, generally employs three different temperatures. Reaction temperatures are typically 90° C. to 94° C. for denaturation, 55° C. to 72° C. for renaturation, and 70° C. to 75° C. for extension. Target DNA species are cycled through these temperatures 20-40 times in the presence of an appropriate mixture of reagents to obtain exponential amplification. Non-uniform temperatures tend to reduce the efficiency of the PCR.

Another cyclic reaction is the ligase detection reaction (LDR), which is used to detect rare mutations. LDR typically comprises two steps: denaturation (90°-95° C.) and ligation (60°-65° C.). Non-uniform temperatures also tend to reduce the efficiency of the LDR.

Bench-top PCR instrumentation typically consumes about 20-100 μl of reagents for amplification of DNA. Further, these instruments are inconvenient for portable or real-time use, and they are relatively slow because of the system's slow heating/cooling cycle time.

Often, microchamber PCRs are designed more-or-less as direct miniatures of commercial bench-top PCR machines. (For example, see Sun, Y. and Kwok, C. Y., 2006, “Polymer Microfluidic System For DNA Analysis,” Analytica Chimica Acta, vol. 556, pp. 80-96.) As with the bench-top thermal cyclers, micro-cyclers tend to show decreased dynamic performance because of the thermal capacitance of the sample container and heating/cooling system. Such devices typically operate by holding reactants in a single chamber while the temperature of the entire chamber is cycled.

Continuous flow PCRs (CFPCR) rely on a continuous flow of reagents through two or three nominally iso-thermostatic zones. (For example, see Kopp, M. C., De Mello, A. J., Manz, A., 1998, “Chemical Amplification: Continuous-Flow PCR On A Chip,” Science, vol. 280, no. 5366, pp. 1046-1048.) This method allows for rapid amplification. However, existing CFPCRs may consume relatively large reagent volumes.

Barany, et al. (U.S. Pat. Nos. 7,312,039, 7,014,994, 6,534,293, and 6,027,889) disclose a bench-top method for combining LDR with PCR. PCR-amplified products are mixed with two LDR primers that flank the mutation of interest (common primer and discriminating primer) and a DNA ligase enzyme. The enzyme-DNA ligase mixture is cycled about 20 times between 95° C. (15-30 seconds/cycle) and 65° C. (2-4 minutes/cycle), and then quenched at 4° C. Resultants were then analyzed by another technique such as electrophoresis outside the reaction chamber. The entire process takes about 2½ hours or longer.

Rapid amplification has been performed using a polycarbonate CFPCR device for 500 bp and 997 bp DNA amplicons. (Hashimoto, M., Chen, P.-C., Mitchell, M. W., Nikitopoulos, D. E., Soper, S. A., and Murphy, M. C. (2004) “Rapid PCR In A Continuous Flow Device,” Lab-on-a-Chip, 4(6):638-645.) The time required for 20 cycles for a 500 bp amplicon was 1.7 min. The time required for a 997 amplification was about 3.2 minutes (9.7 s/cycle). Amplification efficiencies for this device when compared to similar amplicons generated from a bench-top thermal cycler were about 25% at 1 mm/s linear velocity, about 20% at 2 mm/s, and about 10% at 3 mm/s. It appears that the main cause of low efficiency was the uneven temperature distribution within the CFPCR channels.

Recently, solid-phase purification of nucleic acids, such as DNA sequencing fragments and genomic DNA (gDNA) from whole cell lysates, was demonstrated using UV-exposed, PC-based microdevices. However, these devices were limited to a single channel format and may not be appropriate for high throughput applications. (Witek, M. A.; Llopis, S. D.; Wheatley, A.; McCarley, R. L.; Soper, S. A. Nucleic Acids Res., 2006, 34, e74/71-e74/79.)

There are unfilled needs for precise passively aligned polymeric modular microdevices, which will allow for efficient direct combination of functions such as mixing, incubating, reacting, and purifying, and for a method to fabricated precise passively aligned polymeric modular microdevices, comprising direct combinations of functional units such as mixing, incubating, reacting, and purifying. There are also unfilled needs for efficient multi-temperature-zoned microreactors and for a method for fabricating efficient multi-temperature-zoned microreactors.

We have discovered polymeric modular microfluidic units that are passively aligned using exact kinematic constraints, and a method for fabricating polymeric modular microfluidic units, which may comprise a plurality of single elements devices or multi-element devices, and which are passively aligned using exact kinematic constraints. We fabricated metallic molds for microfluidic devices, and from those molds we formed polymeric microdevices. The polymeric microfluidic devices were formed with alignment structures to allow precise combination of separate units. Adjacent units were constrained in six degrees of freedom when fabricated with three sets of matching alignment features. Typically, molds were made using brass or nickel, and then a polymer, for example polycarbonate (PC), was forced into the molds to form the desired structures.

We have assembled polymeric microfluidic units, for example, preheating and incubating chambers or channels, and cycling reactors by using a combination of three sets of hemispherical posts and grooves. We also have been able to precisely assemble units of polymeric microdevices that combine purification of nucleic acids with DNA amplification.

In one embodiment, we fabricated three v-shaped recesses on a first micro-unit, which were aligned with three corresponding hemispherical posts on a second micro-unit. For this embodiment the relative sizes of the posts and the corresponding recesses were such that a post contacted a recess at two and only two points. While similar methods have been used before for harder materials, it is not known to have been implemented on microdevices fabricated from polymers, which are usually considered non-precision materials.

In another embodiment, we were able to form more precise hemispherical posts by incorporating an extra annular structure around each hemisphere-mold. Without wishing to be bound by this theory, it appears that the annular structure may have reduced the polymer flowing distance and may have increased the local molding pressure to fill the negative hemisphere-tipped recesses with the polymer more efficiently during molding. Using this method, we have been able to align polymeric microstructures to a precision less than 20 μm.

In addition, we have discovered polymeric multi-temperature-zone microreactors having isolated and distinct temperature zones, and we have developed a method for fabricating polymeric devices that are efficient multi-temperature-zone microreactors having isolated and distinct temperature zones. The microreactors were fabricated by using lithography to form a chip wherein a microchannel passes through more than one temperature zone. The polymer substrate was thin, and each temperature zone was separately heated. A separate conducting layer was attached to one side of the substrate for each temperature zone, and a heater was attached to the conducting layer. Grooves were fabricated between temperature zones on the side of the chip opposite to the conducting layer. Surprisingly, when we combined thin polymeric substrates, grooves between zones, and conducting layers between heaters for each zone, we obtained remarkable thermal separation between zones, which enabled improved functionality of the reactor. For example, we have fabricated CFPCR microreactors with three distinct and isolated heating zones, whereby our reactor was competitive or better than other CFPCR microreactors for amplification of DNA.

Such reactors can efficiently transfer analytes and reagents through well-defined temperature zones on a continuous basis. These reactors overcame the inefficiency of large chamber-type devices by eliminating the need to heat and cool the entire device at each step, and avoided the inefficiency of existing continuous microreactors by maintaining isolated temperature zones with minimal thermal contamination between zones.

### BRIEF DESCRIPTION OF DRAWINGS

FIG. 1A depicts a polymeric micro-alignment hemispherical post structure.

FIG. 1B depicts a polymeric micro-alignment hemispherical post with an annular structure.

FIG. 1C depicts a polymeric micro-alignment v-groove structure.

FIG. 1D depicts an assembly of a polymeric v-groove and a hemispherical post with an annular structure.

FIG. 2 depicts schematically a side view of a generic multi-temperature zone reactor.

FIG. 3 depicts schematically a prototype CFPCR device.

FIG. 4 depicts schematically a prototype LDR device.

FIG. 5 depicts schematically a prototype modular PCR-LDR device.

### PASSIVE MODULAR ALIGNMENT

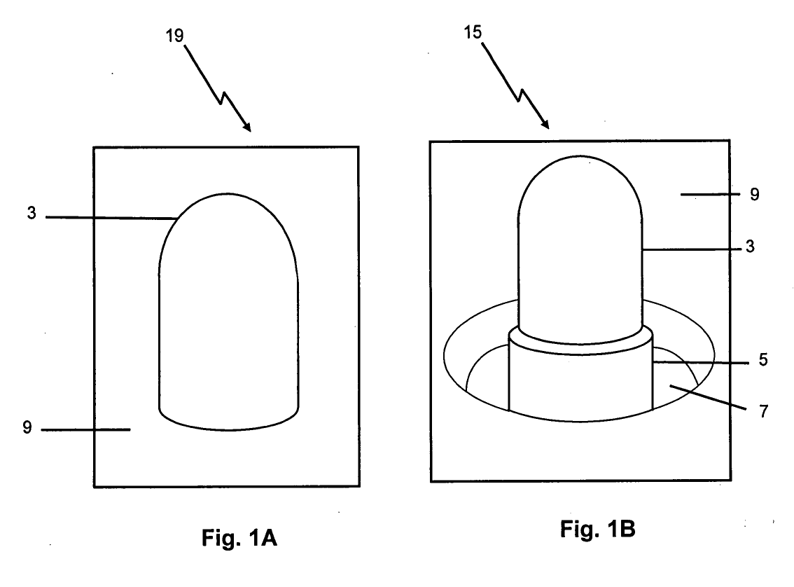

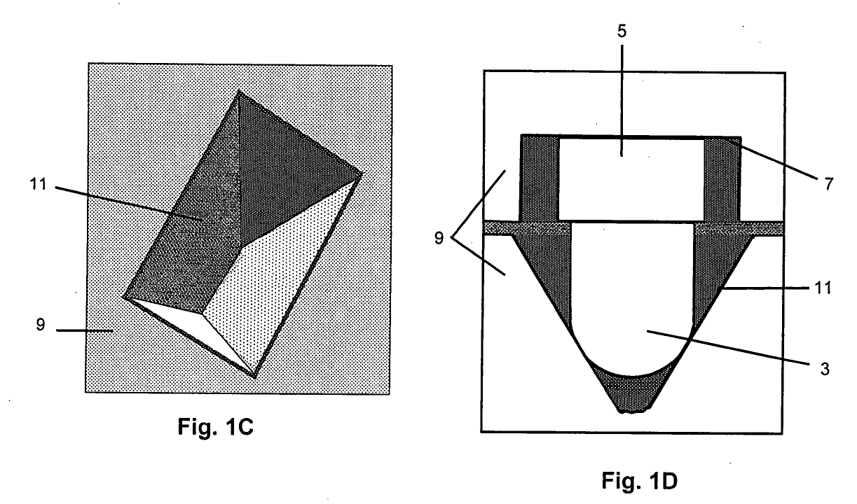

FIG. 1A shows one embodiment for a first alignment structure, a hemispherical post (3). The post was fabricated from polycarbonate. FIG. 1B shows another embodiment for a first structure for alignment, a hemisphere-post (3) with an annular structure (5) and a recess (7). The base of the post (3) was part of the component to be aligned (9). Without wishing to be bound by this theory, it appears that the annular structures structure may have reduced the polymer flowing distance and may have increased the local molding pressure to fill the negative hemisphere-tipped recesses with the polymer more efficiently during molding.

FIG. 1C shows a v-groove second alignment structure (11), which was adapted to mate with the first alignment structure (3). When three sets of alignment features were fully implemented, they constrained two opposing devises in six degrees of freedom. Six degrees of freedom refers to motion in three dimensional space, namely the ability to move forward/backward, up/down, left/right (translation in three perpendicular axes) combined with rotation about three perpendicular axes. The movement along each of the three axes is independent of each other and independent of the rotation about any of these axes. When the first structure (3) was mated with the second structure (11), the device to which the first structure was attached and the device to which the second structure was attached became aligned in one dimension, as shown in FIG. 1D. When a second pair of alignment structures was added in a different plane, each alignment pair constrained the opposing devices in two additional dimensions, resulting in constraining the relative alignment of the attached devices in four degrees of freedom. When a third pair of alignment structures was added in a different plane, the opposing devices were constrained in three dimensions and in three rotations relative to each other.

Brass mold inserts were fabricated using a micro-milling machine. The patterns of the mold inserts comprised v-shaped pyramids, hemispherical tipped recesses with annular walls, and rectangular steps for the replication of assembly features and alignment marks. Other geometric shapes, such as ellipses, trapezoids, pentagons, or hexagons may be used; it is preferred that the post only contacts two points within the recess.

In one embodiment, v-shaped recesses (11) were between about 1.5 mm and 2.5 mm wide, between about 0.8 mm and 1.2 mm deep, with slopes of about 45° relative to the substrate plane, and between about 2 mm and 6 mm long. Hemispherical-tipped posts (15) were between about 800 μm and 1000 μm high, with diameters between about 0.5 mm and 1.5 mm. Annular structures (5) were between approximately 300 μm and 700 μm high, and between approximately 300 μm and 700 μm wide. The annular structures were located so that the distance between the inner wall of the annulus and the edge of the hemisphere recess was between about 100 μm and 500 μm.

### EXAMPLE 1

In one prototype, v-shaped recesses (11) were about 2 mm wide, about 1 mm deep, with slopes of about 45° relative to the substrate plane, and about 4 mm long. Hemispherical-tipped posts (15) were about 925 μm high, with diameters of about 1 mm. Annular structures (5) were about 500 μm high and about 500 μm wide. The annular structures were located so that the distance between the inner wall of the annulus and the edge of the hemisphere recess was about 100 μm.

### EXAMPLE 2

In another prototype (not shown), three straight slots with semicircular ends about 1 mm wide with an end radius of about 0.5 mm and 2 mm long were fabricated on a first unit. Two of the slots were parallel to each other, and the third slot was orthogonal to the other two slots and located on a perpendicular line from the second slot. Three hemispherical pins about 0.5 mm in diameter were fabricated on a second unit that was to be modularly assembled with the first unit wherein each pin was adapted to mate with one slot. The three hemispherical pin-in-slot alignment structures provided complete constraint between the two units.

The molds for v-groove pyramids were positive structures, while the molds for hemispherical recesses were negative structures. The negative structures were more difficult to fill with polymer flowing from a flat surrounding area when compared to polymer flowing from a positive structure such as a pyramid v-groove.

Embossed plates were assembled manually using the alignment features, comprising a set of three v-grooves and three corresponding hemispherical posts, which passively constrained the plates. After alignment, epoxy was used to bond the two plates together.

### EXAMPLE 3

To confirm alignment accuracy, prototype polymer replicas were fabricated from brass mold inserts using hot embossing with 6 different layouts of hemispherical posts. Five post designs (15) were fabricated with an annulus so that distances of 100 μm, 200 μm, 300 μm, 400 μm, or 500 μm existed between the inner wall of annular structures and an edge of hemispherical structures. The sixth structure had no annular structure (19). Alignment structures were located radially from the center at distances of 12 mm, 24 mm, and 36 mm. Hot embossing was performed using polycarbonate (PC) so that approximately 5 mm thick polymer devices were formed. Other polymers may also be used.

The alignment accuracy was estimated by measuring the mismatches between alignment marks on both plates. The embossed plates were washed with isopropyl alcohol and deionized water; dried in nitrogen gas; and then baked at about 70° C. for about 1 hour to remove any residual contaminants. The devices were cut so that cross-sectional areas of assembled alignment marks were exposed. The cut surfaces were polished by hand. Misalignment was measured using a microscope. Mismatches observed were from about 2 μm to about 20 μm, which was a remarkable improvement in aligning polymeric modular microstructures when compared to mismatches of 28 μm to 75 μm previously observed.

Microfabrication of the CFPCR Multi-Reactor Devices

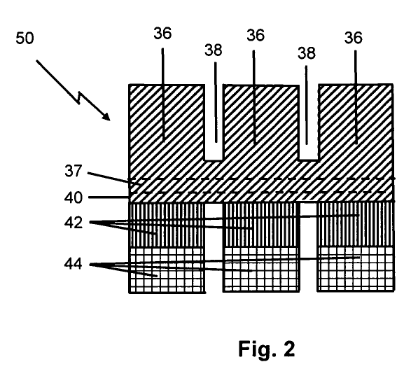

A microreactor (50) with precise heating zones was fabricated in a polymeric substrate (36), a generic schematic of which is shown in FIG. 2. The microreactor comprised a microchannel (37), three separate regions or zones with thin walls (40), grooves between the zones (38) on one side of the substrate, a highly conducting material (42) attached to the substrate (36) on the side opposite the grooves (38), and heaters (44). The conducting material, which may be one or more layers and may be rigid or complaint, was inserted between a heater (44) and the polymeric substrate (36). The highly conductive material (42) is separately attached to the part of the substrate (36) that corresponds to a particular heating zone. Heat from separate heaters (44) was applied to the highly conducting material (42). The highly conductive material used was copper, but other metals such as silver, gold, and aluminum may be used. Other conductive materials such as graphite also may be used.

In one embodiment, fabrication began with microfabricating a mold using LIGA, followed by hot embossing of polymer, for example, PC, to a thickness of between approximately 1.8 mm and 5.2 mm. Other polymers with glass transition temperatures above the operating temperature of the device also may be used. Inlet and outlet ports, each having approximately between 0.5 and 2.0 mm diameters, were mechanically drilled into the microchips. The chips were rinsed with isopropanol and deionized water, and then baked at between about 70° C. and 90° C. for about 30 min. Thin PC sheet stock, which was typically about 0.20 to 0.30 mm thick, was used to seal the microchannels by thermally bonding polymeric sheets to the reactorchips. Borosilicate glass plates were used to hold polymeric sheets in place while sealing the microdevice. Typically, the same material used for the microdevice was also used for sealing sheets. The entire assembly was subsequently heated to between about 150° C. and 175° C. for about 20 min. The overall thickness of the bonded microdevices was decreased to between about 1.9 mm and 2.1 mm by flycutting. Grooves, which were between about 0.8 mm to 1.2 mm wide and between about 0.7 to 1.4 mm deep, were micro-milled on the backside of the chips. A thermally conductive layer, for example copper, was then attached to the substrate on the side opposite to the grooves. In some embodiments, more than one conducting layer was used, for example, thermally conducting paste or tape. Insets were milled on one side of the thermal material for the chips to be seated, and on the other side for the heaters and thermocouples to be mounted. In operation, heat may be applied to the thermal conducting layer, for example, a copper plate attached to each polymeric temperature zone.

### EXAMPLE 4

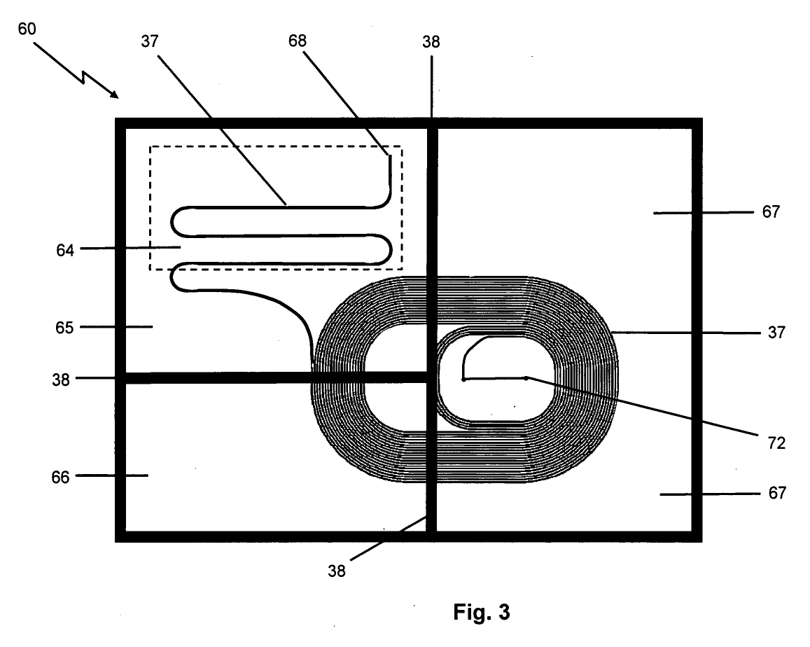

Fabrication of a prototype CFPCR (60) comprised microfabricating a mold for a spiral CFPCR using LIGA, followed by hot embossing of PC to a thickness of about 2.3 mm. As shown in FIG. 3, this device comprised an inlet port (68), an outlet port (72), a pre-heater (64), a microchannel (37), three temperature zones (65), (66), and (67), and grooves (38) between the zones. Other polymers with glass transition temperatures above the PCR denaturation temperature of about 95° C. also may be used. Inlet (68) and outlet (72) ports, each having approximately 1 mm diameters, were mechanically drilled into the microchips. The chips were rinsed with isopropanol and deionized water, and then baked at about 80° C. for about 30 min. Thin PC sheet stock (not shown), which was approximately 0.25 mm thick, was used to seal the microchannels by thermally bonding the PC sheets to the reactorchips. Borosilicate glass plates were used to hold the PC sheets in place while sealing the microdevice. The entire assembly was subsequently heated to about 168° C. for about 20 min. The overall thickness of the bonded microdevices was decreased to about 2 mm±5 μm by flycutting. Grooves (38), which were about 1 mm wide and about 1.2 mm deep, were micro-milled on the backside of the chips.

### EXAMPLE 5

To determine the degree of thermal isolation of heating zones in the device of Example 4, an infrared camera was used to measure the temperature of each zone. Tops of the CFPCR chips were sprayed with a thin layer of a black paint suitable for thermal investigations. The multi-temperature zone system and the IR camera were enclosed in a black box to shield the device from ambient optical and thermal disturbances. After a steady-state temperature distribution was achieved, IR images of the CFPCR were captured.

Three different multi-temperature devices like the device in Example 4 were fabricated. The purpose of the three devices was to show the effectiveness of the parts of the device in Example 4. The first device was like the device in Example 4 except it was without copper heating stages or grooves. The second device was like the device in Example 4 except it was without grooves. The third device was the device in Example 4, comprising a copper heating stage, a thin substrate, and micro-milled grooves between temperature zones.

The first and second devices did not show improvement over prior attempts to isolate temperature zones. The prototype multi-temperature device in Example 4 exhibited an average temperature within a zone to be the desired temperature, and at the groove between the 95° C.-zone and the 55° C.-zone the average temperature change was ±4.1 C/mm. This change was approximately that observed for bench-top, closed-loop, reactors, with controlled copper plates and heaters. In prior attempts to isolate temperature zones in polymers, it was observed that the temperature of the “55° C.-zone” never got lower than 65° C. when adjacent to a “95° C.-zone.” (M. Hashimoto, P. C. Chen, M. W. Mitchell, D. E. Nikitopoulos, S. A. Soper, M. C Murphy, Lab on a Chip, 4, 638 (2004).) Without wishing to be bound by this theory, it appears that grooves reduced lateral heat conduction from higher temperature zones to lower temperature zones because the thermal conductivity of air (0.0263 W/m° K) is an order of magnitude smaller than that of polycarbonate (0.2 W/m° K). In addition, the grooves also appeared to define distinct thermal capacitances for each zone so that a target temperature could be attained with less input power. Faster cooling was also possible since less power needed to be dissipated. Thinner substrates and the one or more rigid or compliant layers of highly conducting material between heaters and polymeric substrates appeared to improve heat transfer from heaters into micro-channels.

In one prototype (not shown), optional fins were added within the grooves, typically near the center of the groove. It appeared that the fins helped transfer heat away from the substrate between temperature zones.

A prototype CFPCR (60), as shown in FIG. 3, comprised three temperature zones [(65), (66), and (67)], grooves (38) separating the zones, a spiral microchannel (37), and a preheating zone (64) (typically held at about 95° C.). A premixing chamber may also be included. The grooves were approximately 1.2 mm deep and 0.4 mm wide. The spiral microchannels were approximately 150 μm deep, 50 μm wide, and 1.78 m long.

This prototype reactor (60), as shown in FIG. 3, was used to amplify DNA by PCR. A PCR reagent mixture was injected from a capillary tube into the spiral microchannel (37) through an inlet (68) and then preheated (64) at about 95° C. The reactants were then cycled on a spiral path (37) through the three isothermal zones 20 times. The resulting products were collected from an outlet capillary tube (72). The overall dimensions of the microdevice were about 5.5 cm by 5.0 cm.

The temperature distribution along the microchannel changed for different flow velocities. For our prototype CFPCR (60), flow velocities tested were about 2 mm/s, 4 mm/s, and 6 mm/s. As the flow velocity increased, the DNA amplification was less effective. Without wishing to be bound by this theory, it appears that as the flow velocity increased the DNA spent less time in the controlled temperature zones.

In this prototype CFPCR (60), as shown in FIG. 3, there was an inner channel path and an outer channel path within the reactor. The ratio of the channel lengths within the three temperature zones in the innermost microchannel was about 1:1:4 (denaturation, renaturation, and extension), and the ratio of channel lengths within the three temperature zones in the outermost microchannel was about 1:1:3. The length of the extension zone was longer than the other two zones because it typically requires more time for DNA extension than for denaturation or renaturation. Denaturation and renaturation occurred in less than 1 second, while extension appears to have occurred in about 3-4 seconds. Approximately 5 seconds was needed to generate a 500 bp amplicon.

A prototype CFPCR (60) was used for the PCR amplification of sample bacteriophage DNA. At a flow rate of about 2 mm/s, the amplification efficiency was about 72.7% of that of a bench-top thermal cycler. However, the prototype CFPCR (60) performed (including preheating and post-heating) in about 30 s/cycle (total time was about 14.8 min), while the bench-top PCR required 270 s/cycle. At higher velocities, the relative amplification efficiency (as compared to a bench-top PCR) decreased to about 44% at 3 mm/s, about 29.4% at 4 mm/s, and about 20% at 6 mm/s. However, the amplification efficiency of this CFPCR was about 300% better than has been reported for other micro PCRs at 2 mm/s and about 400% better at 3 mm/s. (For example, see Hashimoto, M., Chen, P.-C., Mitchell, M. W., Nikitopoulos, D. E., Soper, S. A., and Murphy, M. C. (2004) “Rapid PCR In A Continuous Flow Device,” Lab-on-a-Chip, 4(6):638-645.) While not wishing to be bound by this theory, the lower overall yield of this micro-CFPCR when compared to a commercial bench-top thermal cycler may be due to several factors, including the possibility that the Taq polymerase may have had more opportunity to adsorb on the microchannel walls due to the high surface-to-volume ratio of the long channel. Further, since the components flowed at similar flow rates within the microchannel, less mixing of reagents may have occurred.

### EXAMPLE 6

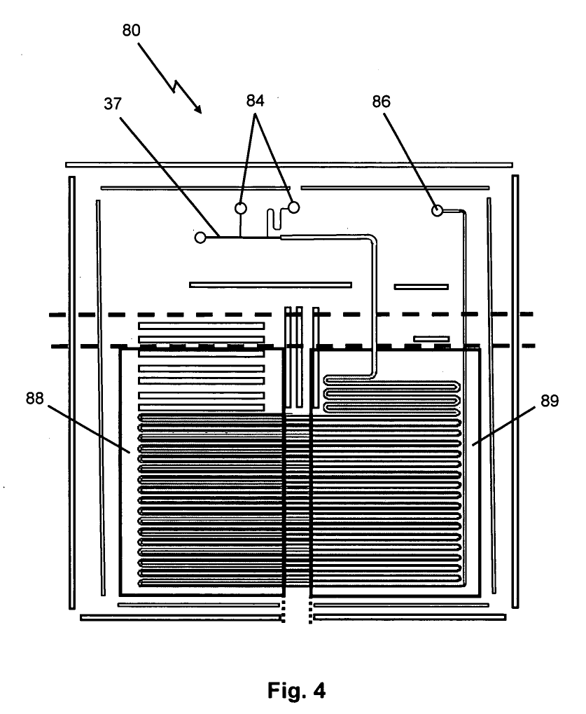

The ligase detection reaction (LDR) (80) also may be performed in a cyclic reactor. FIG. 4 depicts a prototype LDR comprising inlets (84), an outlet (86), a microchannel (37) and two primary temperature zones (88) and (89). LDR typically amplifies by cycling reactants between 95° C. and 65° C. for 20 cycles. Reactants were held at 95° C. for about 15 seconds/cycle and then at 65° C. for about 30 seconds/cycle. In our cyclic micro-LDR reactor, good amplification yield was obtained in about 15 minutes. In contrast, macroscale LDR amplification typically requires between 45 min. and 90 min. Our prototype device showed that one mutant sequence in 100 mutant sequences could be detected in about 20 min., while a commercial instrument requires about 270 minutes. Heating zones were made to be of comparable size by varying the cross-section of the microchannel within each zone to achieve the desired residence times.

### EXAMPLE 7

Fabrication of Micro-Titer Plates

We used UV lithography on SU-8 and nickel electroplating to fabricate titer plate-based microfluidic platforms. Initially, SU-8 was deposited onto a silicon substrate, and then SU-8 was exposed to UV radiation through an optical mask with the desired design to form a polymeric template for electroplating. Metal large area mold inserts (LAMIs) fabricated in SU-8 via UV-LIGA were used to mold polymer chips using hot embossing for polymer microfluidic platforms. Nickel was electroplated onto SU-8, and then this unit was overplated with nickel to a thickness of about 3-5 mm. The nickel was then milled to a thickness of about 3 mm, with a thickness variation over the entire plated area of about 50 μm. Following the milling, the device was cut to a circle using a water jet. The Si substrate was then removed using KOH etching, and the SU-8 was stripped using a plasma etch. Modular microfluidic units may be assembled with the novel method of alignment, as described generally in Example 1. The assembled chips were sealed by thermal fusion bonding. Other methods of sealing, for example use of adhesives, could also be used.

In one embodiment we used hot embossing as a molding technique to form microstructures over large surface areas. Using hot embossing, we fabricated a 96-well SPE reactor with square microposts as small as 10 μm. While some of the 10 μm microposts near the edges of the chip were not complete, when we formed 20 μm square microposts, we obtained nearly 100% replication quality over the entire 150 mm diameter mold insert area.

A nominal well-to-well spacing of about 9 mm was used for PC molded micro-titer-plates to take advantage of existing multi-channel pipettes or robotic equipment for sample and reagent handling such as those used in conventional 96-well titer-plate platforms. To achieve a nominal 9 mm well-to-well spacing in the large area nickel mold inserts, the mold spacing was slightly larger than 9 mm to allow for shrinkage during hot embossing. Measured well-to-well spacing in the embossed PC chips after shrinkage was 8.999 mm±0.004 mm.

A micro-milling machine was used to precisely drill 96 reservoirs to a depth of about 4 mm into the 5 mm microchips formed from hot embossing. Laser drilling was then used to drill through the remaining approximately 1 mm for each of the 96 reservoirs to avoid polymer burrs. Alternatively, double-sided hot embossing with two master molds may be used to define the additional access holes and reservoirs simultaneously during the micro molding to reduce post-processing overhead and accommodate mass production.

Prior to sealing, the embossed PC chips and cover plates were exposed to UV radiation at a wavelength of about 254 nm and an intensity of about 15 mW/cm² for about 30 min. Without wishing to be bound by this theory, it appears that the UV radiation modified the PC surfaces to have a lower glass transition temperature, which allowed thermal fusion bonding to occur at a lower temperature. Further, it appears that the UV treatment caused carboxylate groups to form on the surfaces, which may have immobilized nucleic acids.

### EXAMPLE 8

In one prototype microfluidic unit, an epoxy-based, negative photoresist, SU-8, was spin-coated onto a 150 mm diameter Si substrate, which had been pre-coated with an e-beam-evaporated seed layer of Cr/Au (20 nm/50 nm). This material was then baked, first at about 65° C. and then at about 95° C. The SU-8 coated Si substrates were then subjected to conventional UV lithography using a 1 kW broadband mercury UV lamp. After exposure, the SU-8 coated Si substrates were again baked, first at about 65° C. and then at about 95° C. The UV-exposed units were then developed in an SU-8 developer (propylene glycol/methyl ether acetate (PGMEA)), rinsed with isopropyl alcohol, and dried in air. Prior to nickel electroplating, the SU-8 templates were treated with an oxygen plasma de-scum (100% O₂ at about 150 mT pressure) to remove SU-8 residue and trace isopropanol.

Metal mold inserts were fabricated by plating nickel from a nickel sulfamate solution onto the SU-8 templates. The electroplating solution comprised electronic grade nickel sulfamate (180 g/L), boric acid (minimum purity of 99.8%), and E-liminate Pit (a wetting agent purchased from Dischem, Inc. (Ridgway, Pa., USA)). The electroplating solution was continuously circulated and filtered. Sulfur-depolarized nickel pellets (Inco “S” rounds, Belmont Metal Inc., Brooklyn, N.Y., USA), used to maintain a supply of nickel ions, were encased in a 250 mm by 213 mm titanium anode basket during electroplating.

Upon completion of electrodeposition, surfaces of the mold inserts were milled to a thickness of about 3 mm, with a total thickness variation of less than 50 μm. The nickel mold inserts were cut to a diameter of about 135 mm using a water jet. The Si substrate was then removed using a 25% KOH solution. Then the SU-8 was removed using microwave plasma dry etching. Circular cavities with diameters of about 135 mm and depths of about 3 mm were machined into stainless steel plates having thicknesses of about 6 mm and diameters of about 150 mm. Holes were drilled in each cavity to enable mounting of the nickel mold inserts in the stainless steel plate circular cavity using laser welding. The nickel molds were then placed in these cavities.

Nickel oxide is known to form at the interface between electroplated nickel and a seed layer on the substrate, which can then be a cause for weak adhesion of nickel structures to the substrate. Overplating of nickel was therefore a preferred method for making mold inserts, which was done by initially fabricating dummy rectangular patterns with a spacing of between about 0.5 mm and 1 mm over the entire substrate area prior to electroplating the nickel. Pre-coating a seed layer on the top surface of the SU-8 may also be used. The initial current density for electroplating in the cavities was 7-10 mA/cm². The current was then increased to about 20-40 mA/cm² to complete the overplating of the base of the mold inserts, resulting in mold inserts about 3.5 mm thick.

After electrodeposition, SU-8 was removed using 1-methyl-2-pyrrolidone with strong agitation at 95° C. to reveal the metallic microstructures. However, this process sometimes left unwanted SU-8 residue between small structures. Thus, an isotropic plasma dry etch, using a microwave plasma asher, was used for removal of SU-8 residue. The optimum conditions for microwave plasma ashing were found to be in an atmosphere of about 25% CF₄/75% O₂ at about 700 mTorr with an incident power of about 500 W.

Polymeric devices were then made using the metallic molds. PC sheets about 5 mm thick were molded by hot embossing. The PC sheets were initially cut into octagons about 200 mm wide, and dried at about 80° C. for about 12 h. A mold release agent was used. A molding pressure of about 200 psi was applied for about 2 min at a mold temperature of about 190° C. Demolding followed at a temperature of about 140° C. After embossing, the PC chips were cut to the size of a standard 96-well titer plate. Two holes, each about 1 mm in diameter, were drilled for the microfluidic ports. The embossed PC chips and 500 μm thick PC cover plates were cleaned first with a 1% solution of Liqui-Nox (Jersey City, N.J., USA) in DI water. Then the PC chips were rinsed in a DI water/isopropyl alcohol mixture, and then with DI water. The PC chips and covers were dried at about 75° C. for about 12 h.

### EXAMPLE 9

A prototype titer plate-based microfluidic platform comprising a 96-well solid-phase reversible extraction (SPE) reactor was fabricated. Solid-phase extraction can be used, for example, to purify nucleic acids from complex biological matrices. Two multi-well SPE reactors were designed with different sizes of microposts. For one prototype reactor, a 96-well SEP plate comprised posts with nominal diameters of about 10 μm, with center-to-center spacings of about 20 μm; two microfluidic control ports; a microchannel network; and 96 immobilization capture beds with reservoirs at each well location. Each well had a total surface area of about 43.1 mm² and a volume of about 263 mL.

### EXAMPLE 10

Another prototype 96-well SEP plate comprising posts with nominal diameters of about 20 μm, with center-to-center spacings of about 40 μm; a microchannel network; and 96 immobilization capture beds with reservoirs at each well location was also fabricated. Each well had a total surface area of about 28.4 mm² and a volume of about 277 mL.

### EXAMPLE 11

In operation of the titer-plates, typically a syringe pump (push-mode) was connected to the inlet port, and a vacuum pump (pull-mode) was connected to the outlet port. Each well was configured to have approximately the same pressure drop between ports. Nucleic acids were introduced at each reservoir by either standard manual or robotic loading equipment, and a vacuum was pulled on the outlet port. Nucleic acids were immobilized on the surfaces of the microposts, and most of the cell debris and proteins were washed away. Ethanol was used to remove any remaining cell debris and proteins from the system. The SEP beds were dried and then washed with deionized water to elute purified DNA.

### EXAMPLE 12

We also fabricated a photo-activated polycarbonate SEP (PPC-SEP) microfluidic chip for the high-throughput purification of a variety of nucleic acids from whole cell lysates or whole blood. High-throughput operation was achieved by placing 96 purification beds, each containing an array of 3,800, 20-μm diameter posts, on a single 3″×5″ polycarbonate (PC) wafer fabricated by hot embossing. All beds were interconnected through a common microfluidic network that permitted parallel access through the use of a vacuum and syringe pump for delivery of an immobilization buffer (IB) and effluent. Nucleic acids were adsorbed onto UV-modified PC surfaces within the reactor in the presence of an immobilization buffer comprising polyethylene glycol (PEG), NaCl, and ethanol. The ratios of the IB reagents depended on the size of the polynucleotide to be isolated and the matrix from which it was isolated. The performance of the device was validated by quantification of the recovered material following PCR (for DNA) or RT-PCR (for RNA). The extraction bed load capacity was about 206±93 ng for DNA and about 165±81 ng for RNA from E. coli. The purification process was fast (<30 min), easy to automate, and inexpensive.

### EXAMPLE 13

We characterized the performance of the 96-well PPC-SEP plate described in Example 12 by monitoring the extraction of DNA from E. coli whole cell lysates. A mixture of about 20 μL of lysates and IB was dispensed into each of the 96 sample reservoirs. The samples were drawn through the purification beds at an average flow rate of about 1.8±0.7 μL/min. Ethanol (85%) was used to wash the beds. Isolated DNA was released from the PPC-SPE surface using deionized water. At surface saturation, the concentration of extracted DNA was determined to be about 13.7±6.2 μg/mL, yielding a mass of isolated DNA of about 206±93 ng with a surface density of about 724±327 ng/cm². Variation of recovery of DNA from plate to plate was determined to be about 35%±10%. The average surface loading density of DNA was comparable to the previously reported value of 790 ng/cm² for E. coli DNA captured in a single bed format. (Witek, M. A.; Llopis, S. D.; Wheatley, A.; McCarley, R. L.; Soper, S. A. Nucleic Acids Res., 2006, 34, e74/71-e74/79.) We estimated the variability of the flow rate through each extraction bed to be about ±37%. The 96-well chip prototype had an average recovery efficiency for DNA of about 63%±24%. We also determined that this prototype PPC-SPE plate exhibited essentially no cross-contamination among the wells.

### EXAMPLE 14

Successful PCR of samples taken from whole blood is known to depend on how well PCR inhibitors, such as hemoglobin, are removed. We used our 96-well PPC-SPE plate to purify DNA of various sizes from blood samples. Whole blood was spiked with 3 different bacterial species: gram-positive Bacillus subtilis (4.2 Mbp genome), Staphylococcus aureus (2.8 Mbp genome), and gram-negative bacteria Escherichia coli (4.8 Mbp genome). We also examined λ-DNA (48.5 kbp) and single-stranded (ss) M13mp18 (7.2 knt).

The blood samples were seeded with bacterial cells and mixed with buffer, followed by thermal lysing. The λ-DNA template and ssM13mp18 followed the same general procedure, but with a different buffer. A higher PEG concentration was used for λ-DNA and M13mp18 to promote condensation of shorter DNAs onto the solid support. Amplicons with sizes of 159, 204, 600, and 500 bp for B. subtilis, S. aureus, E. coli, and λ-DNA, respectively, were observed, indicating successful recovery of DNA with the novel PPC-SPE chip. Products of 381 and 272 bps were recovered from ssM13mp18 indicating that the PPC-SPE device also recovered and purified ssDNAs. The novel microdevice provided high quality purification of samples that could be used for a variety of molecular assays, such as the identification of pathogens isolated from whole blood with an anticoagulant, or expression profiling of mRNAs.

### EXAMPLE 15

Blood samples sometimes contain anticoagulants, such as sodium polyanethol sulfonate (SPS) at typical concentrations of about 0.5 mg/mL. Since SPS is a PCR inhibitor, SPS tends to co-purify with DNA when using silica or ethanol-based extraction techniques. We successfully used the PPC-SPE chip to purify blood containing lysed S. aureus and about 0.5 mg/mL SPS. The sample was run through the PPC-SPE reactor, and then between 5 μL and 10 μL of IB was used to remove residual SPS. Then the extraction bed was rinsed with 85% ethanol and dried. The purified DNA was eluted with nuclease-free DI water. Gel electrophoresis confirmed the presence of the PCR products in all cases, with a concentration of SPS in the PCR of less than 0.25 μg/mL.

### EXAMPLE 16

In another embodiment, a spiral-type CFPCR device was fabricated in a hot embossed polycarbonate (PC) chip. In order to use double-sided hot embossing of a 96-well CFPCR multi-reactor chip, two large-area mold inserts, each approximately 6 inches, were designed. A nickel mold insert with microfluidic channels for the CFPCR devices on one side and a brass mold insert for the grooves and fins for thermal isolation on the other side was fabricated.

A set of twelve CFPCR devices (channel widths: of about 10-40 μm, channel depths of about 40 μm, and channel wall widths of about 10-55 μm with 20- to 25-turns) was designed and extended to a 96-well format by placing 8 rows on a plate. The channel widths and lengths in the extension zone of each device were twice the channel widths and lengths in the denaturation and annealing zones, so that the residence time ratio of 1:1:4 (denaturation, annealing, extension) was maintained. Sharing of temperature zones for four adjacent PCR devices was used for efficient thermal control.

Grooves (widths about 1 mm and depths about 1.2 mm) were used between different temperature zones for thermal isolation. In addition, fins (widths about 0.4 mm and heights about 1.2 mm) were fabricated inside some grooves typically near the center of a groove. The fins assisted in dispersing heat between adjacent temperature zones.

The molded PC chips were sealed with PC covers (250 μm thick) using a custom-designed thermal bonding apparatus. The apparatus comprised two stainless steel plates with evenly spaced spring plungers. Wing-nuts were used to compress the spring plungers so that pressure was evenly distributed on the glass plates. The gap between the two steel plates was used to determine the total load applied based on a calibration curve. PC chips were thermally bonded at about 154° C. with a bonding pressure of about 110 psi for about 2 hours. The sealed microchannels exhibited good sealing without deformation, even in the areas where grooves and fins were present. PEEK capillaries, inserted into the inlet and the outlet of a CFPCR device, were fixed with epoxy. Flow of a fluorescent dye through the system confirmed no leakage between the microchannels and showed smooth flow in CFPCR devices with a microchannel width of 20 μm.

### EXAMPLE 17

Polymeric modular microdevices comprising several functional units, for example, for sample purification, amplification, and mutation detection, on small, portable instruments may be fabricated using alignment methods described herein.

### EXAMPLE 18

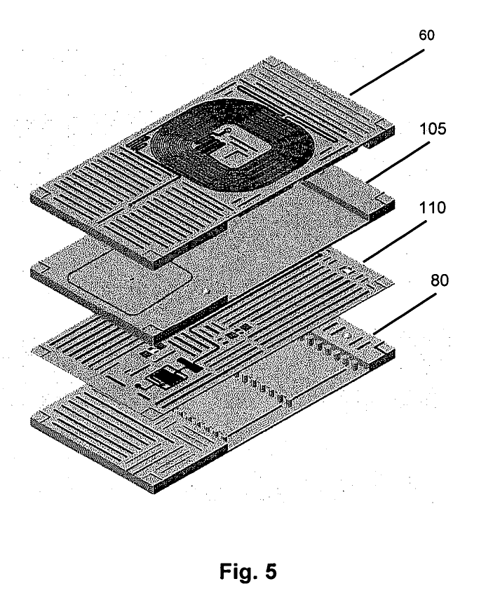

In one embodiment, we combined PCR and LDR (see FIG. 5). FIG. 5 depicts the modular combination of a PCR microfluidic reactor (60), a thermal insulator (105), a passive micromixer (110), and an LDR microfluidic reactor (80). Integration of these functions typically has introduced complexity, slowness, and inefficiency to the overall analysis. The modular unit, with the microdevices aligned using a pin and slot design, performed multi-step functions rapidly and efficiently.

This modular unit was used to detect low-abundant point mutated DNA, which requires a sensitive assay that can distinguish wild-type DNA from mutant DNA. We combined the PCR and LDR devices with an ultra-sensitive fluorescence detector (not shown in FIG. 5) in a single modular unit. The modular microfluidic unit comprised a microfluidic connector that traversed both cyclic reactor modules, a polycarbonate (PC) module for loading samples and reagents, a cell lysis unit with solid-phase extraction (SPE), and a poly(methyl methacrylate) (PMMA) module for detection of the ligation products. The detector comprised a microarray readout, a laser-coupling prism, and an air-embedded waveguide located along the fluidic channel. Both microfluidic reactor modules were fabricated using double sided hot-embossing, with microfluidic channels molded into one side of the PC and thermal separation groves molded into the other side of the PC. The reactor additionally comprised interconnection ports, a coupling prism, and an optical waveguide. PC was the polymer of choice for the thermal modules, requiring high temperatures; PMMA was the polymer of choice for the readout module, requiring good optical properties.

### EXAMPLE 19

A prototype micro-Y-mixer was fabricated. A Y-mixer allowed mixing of three reagents. The pressure balance design allowed operation in both a pull and a push mode. This mixer was combined with other microdevices such as a PCR unit using passive alignment as described herein. Typically the flow ratio for PCR in a micro-Y-mixer was about 1:2:6.

### EXAMPLE 20

A prototype Y-micro-mixer as described in Example 19 was connected with PEEK tubing (0.254 mm I.D. by 0.508 mm O.D.) to syringes and syringe pumps. Three different colored food dyes (Blue, Green, and Red), diluted with water in a ratio of about 1 to 2 (dye to water), were pumped through the micro-Y-mixer at the following rates: red dye at about 0.1392 μL/min, green dye at about 0.0696 μL/min, and then blue dye at about 0.4176 μL/min. Streams were mixed effectively and rapidly.

### EXAMPLE 21

Another prototype microdevice fabricated was a micro-cross-mixer. The micro-cross-mixer allowed mixing of two reagents. This microdevice was combined with other microdevices such as LDRs using passive alignment as described herein. The pressure balance design allowed operation in both a pull and a push mode. The ratio of flow rates was determined by the reaction that followed, and typically the flow ratio between reagents in a micro-cross-mixer for LDR was about 1:9.

### EXAMPLE 22

A prototype micro-cross-mixer, described in Example 21, was connected to a syringe connected to an outlet at the end of the cycling channel. Green dye, flowing at about 0.81 μL/min, and red dye, flowing at about 0.09 μL/min, were injected. Effective mixing occurred in about 7 seconds after injection of the dyes.

### EXAMPLE 23

Prototype micro-Y-mixers and micro-cross-mixers were fabricated using a hot embossing process on PC substrates. The thickness of the PC was about 3.2 mm. The mold inserts were made by micro-milling a groove that was approximately 2 mm by 2 mm on the back of each device. Holes that were approximately 500 μm in diameter and about 2 mm deep were drilled into the substrate with an excimer laser, into which PEEK tubing was connected. Cover slips, comprising PC sheets that were about 125 μm thick, were placed over the devices, and then the entire unit was sandwiched between two glass plates bonded together.

### EXAMPLE 24

In operation, the mixers of Examples 19 and 21 pulled reagents through microchannels, and drops in pressure and flow rates were balanced by adjusting the lengths and widths of the microchannels. Typically, mixers were interfaced with cyclers. An incubator was sometimes added between mixers and cyclers. In one embodiment, reactants were incubated for about 100 seconds in the denaturation zone (95° C.) before the mixture advanced to the cycler. Flow rates through all channels were adjusted to assure the desired residence time in the attached microdevice. Flow rates typically were varied from about 1-10 mm/sec. Typical pressure drops through the entire device were between about 5 psi and 20 psi, and more typically between about 10 psi and 14 psi.

The thermal cyclers interfaced with mixers as described in Examples 19 and 21 typically were configured either in a double spiral or in a serpentine format. Channel dimensions within thermal cyclers varied for different temperature zones to minimize the lengths of the cycler channels, thereby minimizing the instrument's footprint, and to avoid large pressure drops. Residence times necessary for denaturation were typically much shorter than residence times for annealing and ligation. Thus channel widths for ligation/annealing processes were at least 2 times the channel widths for denaturation. The thermal zones had about equal surface area.

The complete disclosures of all references cited in this specification are hereby incorporated by reference. Also made a part hereof by incorporation by reference are the complete disclosures of the priority applications and also Provisional Application Ser. No. 60/856, 415, filed Nov. 3, 2006; and nonprovisional application Ser. No. 11/933,836, filed Nov. 1, 2007. Also incorporated by reference is other work by the inventors, You, B. H., Chen, P. C., Guy, J., Datta, P., Nikitopoulos, D. E., Soper, S. A., Murphy, M. C., “Passive Alignment Structures in Modular, Polymer Microfluidic Devices,” Proceedings of ASME IMECE 2006-16100, Chicago, Nov. 5-10, 2006, used to analyze the state of kinematic constraint of an assembly. Soper et al. (published international patent application no. WO 2007/047606) also have disclosed a thermal cycler and reactor.

We claim:

1. An article of manufacture comprising a plurality of disjoint, polymeric components; wherein:
(a) said polymeric components may have the same or different polymeric compositions;
(b) at least one pair of said disjoint, polymeric components is contiguous to one another;
(c) at least one pair of contiguous polymeric components, comprising a first said polymeric component and a second said polymeric component, comprises a plurality of pairs of alignment constraints; wherein said pairs of alignment constraints are polymeric, and may have the same or different polymeric compositions as said polymeric components; wherein each of said pair of alignment constraints comprises corresponding first and second features, wherein said first feature is a part of said first polymeric component, and said second feature is a part of said second polymeric component; wherein each pair of corresponding first and second features are adapted to engage with one another and thereby to constrain at least one degree of freedom in the relative position of said first and second polymeric components with respect to one another; and
(d) the overall alignment of each pair of contiguous polymeric components with respect to one another, in at least one dimension, is precise to within 100 μm when all of said first and second features are engaged for all of said pairs of alignment constraints associated with said pair of contiguous polymeric components.

2. An article as in claim 1; wherein at least one pair of said contiguous polymeric components comprises at least three pairs of said alignment constraints; wherein the net effect of engaging said at least three pairs of alignment constraints is to constrain five degrees of freedom in the relative position of said first and second polymeric components with respect to one another: three translational degrees of freedom and two rotational degrees of freedom; and wherein the overall alignment of said pair of contiguous polymeric components with respect to one another, in three dimensions, is precise to within 100 μm when all of said first and second features are engaged for all of said pairs of alignment constraints associated with said pair of contiguous polymeric components.

3. An article as in claim 1, wherein the overall alignment of each pair of contiguous polymeric components with respect to one another, in three dimensions, is precise to within 20 μm when all of said first and second features are engaged for all of said pairs of alignment constraints associated with said pair of contiguous polymeric components.

4. An article as in claim 1, wherein each of said pairs of alignment constraints comprises a hemispherical structure as said first feature and a V-groove as said second feature.

5. An article as in claim 4, wherein each of said hemispherical structures additionally comprises an annulus surrounding said hemisphere that increases the precision of alignment as compared to an otherwise identical article of manufacture in which said hemispherical structures lack said annuli.

6. An article as in claim 1, wherein each of said pairs of alignment constraints comprises a pin as said first feature and a slot as said second feature.

7. An article as in claim 1, wherein two or more of said polymeric components are microfluidic devices, and wherein the precise alignment of said polymeric components allows the transport of fluid in one or more aligned vias connecting contiguous microfluidic components.

8. A system comprising a plurality of articles as in claim 7, wherein said plurality of articles is configured in the format of a microtiter plate.

9. An article as in claim 1, wherein the precise alignment of said polymeric components allows an electrical connection in one or more aligned vias connecting contiguous components.

10. An article as in claim 1, wherein the precise alignment of said polymeric components allows an optical connection in one or more aligned vias connecting contiguous components.

11. An article as in claim 1, wherein the precise alignment of said polymeric components allows a thermal connection in one or more aligned vias connecting contiguous components.

12. An article as in claim 1, wherein each of said first and second features has at least one dimension that is less than 1000 μm.

13. An article as in claim 1, wherein each said component performs a substantially different function.

14. A polymeric microdevice comprising a plurality of zones, wherein said microdevice is adapted to maintain said zones at different temperatures, with low heat transfer between adjacent zones; wherein:
(a) at least one groove separates each pair of adjacent zones;
(b) in thermal contact with each zone is a highly thermally conductive material, adapted to transfer heat from a heater to said zone or to transfer heat from said zone to a heat sink, at a uniform temperature that is constant or nearly constant as a result of the highly thermal conductivity of said highly thermally conductive material; and
(c) heat transfer between adjacent zones is substantially lower than it would be between adjacent zones in an otherwise identical microdevice in which no grooves separate adjacent zones.

15. A microdevice as in claim 14, wherein said highly thermally conductive material is selected from the group consisting of copper, silver, gold, aluminum, and graphite.

16. A microdevice as in claim 14, wherein said microdevice comprises at least three said zones; and wherein the lateral dimensions of said microdevice are 4 cm by 4 cm or smaller; and wherein the thickness of each of said zones is 2 mm or less.

17. A microdevice as in claim 14, wherein said microdevice comprises at least three said zones; and wherein the lateral dimensions of said microdevice are 2 cm by 2 cm or smaller; and wherein the thickness of each of said zones is 1 mm or less.

18. A microdevice as in claim 14, wherein each of said grooves comprises one or more fins within said groove to radiate heat away from the groove, thereby reducing heat transfer between zones across said grooves as compared to an otherwise identical microdevice lacking said one or more fins.

19. A microdevice as in claim 14; additionally comprising a plurality of heaters, or additionally comprising a plurality of heat sinks, or additionally comprising at least one heater and at least one heat sink; wherein each said conductive material is in thermal contact with one said heater or is in thermal contact with one said heat sink.
